(19) United States
(12) Patent Application Publication
(10) Pub. No.: US 2003/0228408 A1
(43) Pub. Date: Dec. 11, 2003

(54) Bread equivalents and methods of making the same

(76) Inventor: Jeff Meister, Plymouth, MN (US)

Correspondence Address: THOMAS HOXIE, NOVARTIS, CORPORATE INTELLECTUAL PROPERTY, ONE HEALTH PLAZA 430/2, EAST HANOVER, NJ, 07936-1080, US

(21) Appl. No.: 10/452,401

(22) Filed: Jun. 2, 2003

Related U.S. Application Data
(60) Provisional application No. 60/386,083, filed on Jun. 5, 2002.

(51) Int. Cl. A23L 1/168

(52) U.S. Cl. 426/618

(57) ABSTRACT

A bread equivalent suitable for patients suffering from difficult in chewing or swallowing includes a starch-base and a gelling agent blended to form a dry mix and mixed with a liquid vehicle, such as water. The bread equivalent has properties that are similar to real bread. For example, the bread can be sliced and topped with spreadable foods like butter, margarine and the like. The bread equivalent lacks the glutenous nature of bread making it amenable for ingestion by patients having dysphagia.

### FIELD OF THE INVENTION

The present invention relates to food compositions that have attributes similar to bread yet suitable for ingestion by patients who have difficulty swallowing or chewing.

### BACKGROUND OF THE INVENTION

Bread has been a staple in the diet of man for centuries providing essential nutrients such as protein, carbohydrates as well as vitamins and minerals. For most people, bread is a major component of at least one meal a day. However, for some individuals, bread can be rarely enjoyed because they have dysphagia, or difficulty in chewing and/or swallowing. This is because the gluten in bread makes the bread too elastic. While elasticity is good for rising and making bread higher, it makes bread nearly impossible for dysphagic patients to chew the bread.

Because of bread's nutritional value, healthcare providers have recognized the importance of bread in a patient's diet. In order to make bread accessible to dysphagic patients, bread is typically soaked in water or milk and pureed resulting in a mushy consistency that resembles mashed potatoes. Instead of eating the bread in discrete pieces, the mashed bread is spoon-fed to the patient. Not only is this method of eating bread not appetizing but also ineffective in rehabilitating the patients to regain muscle tone in their jaws.

In addition to its nutritional value, bread serves an excellent carrier for spreadable foods such as butter, margarine or preserves. The bread can also be used with seasonings and toppings such as cinnamon, garlic or sugar. This array of spread and powders can bring diversified tastes to patients who typically drink their.

Thus, there is a need for a bread equivalent that has a nutritional profile and organoleptic qualities similar to that of bread but is also suitable for patients who have difficulty in chewing or swallowing. Furthermore, there is a need for a bread equivalent that is simple and easy to make and relatively inexpensive. There is a need for a bread equivalent that is capable of being used as substitute for bread such that it can be used for sandwiches or as a carrier for a spread.

### OBJECTS OF THE INVENTION

It is an object of the present invention to provide a composition that can be used as a replacement for bread in the diets of patients having difficulty in chewing or swallowing.

It is also an object of the present invention to provide a composition that can be quickly and inexpensively made by a healthcare provider.

It is yet another object of the present invention to have a bread equivalent that has enough mechanical integrity such that it may be sliced by a knife and withstand the stress exerted from applying a spreadable food.

It is a further object of the present invention to provide a method for making such bread equivalents.

### SUMMARY OF THE INVENTION

The present invention features compositions and methods for bread equivalents that can be substituted in the diets of patients that have chewing or swallowing difficulty. The bread equivalents include at least a starch-base, a gelling agent and a liquid vehicle. The bread equivalents can be made first from the starch-base and gelling agent blended into a dry mix and subsequently dispersed into the liquid vehicle. The batter that results from the ingredients can be molded into any shape desired, for example bread slices that are suitable for sandwiches. Unlike other forms of mashed bread, the bread equivalents of the present invention have enough mechanical integrity that allow them to behave like real bread. For example, the breads can be sliced by knife and withstand the stress applied when butter or margarine is applied. The bread equivalents also have nutritional profiles similar to that of real bread making them easily incorporated into the diets of dysphagic patients.

### DETAILED DESCRIPTION OF THE INVENTION

The present invention is a composition that can be used as bread equivalent. What is meant by “bread equivalent” is a composition that can be substituted for bread but is also suitable for patients with dysphagia. A bread equivalent should have a nutritional profile and mechanical integrity (as defined below) similar to that of bread. The bread equivalent should also be capable of being sliced or molded so that it can be made into sandwiches, biscuits and breadsticks. The bread equivalent should be solid enough that it can be broken down into individual pieces or eaten as a single bolus.

What is meant by “bread” is the wheat bread referred to in JEAN PENNINGTON, BOWES AND CHURCH's FOOD VALUES OF PORTIONS COMMONLY USED, 108-109 (15^{th} Ed. 1989). An example of a wheat bread is that made by Pepperidge Farms. As used herein, the term “similar” means relatively the same such that the bread equivalent can be substituted for bread with respect to that attribute. For example, mechanical integrity similar to that of bread means that the bread equivalent has mechanical integrity which is relatively the same as that of bread. For example, if bread can be eaten in a single bolus than so can the bread equivalent.

In order to make a bread equivalent, the present invention features a composition that includes a starch-base, a gelling agent and a liquid vehicle. A “starch-base” refers to any dry bakery product that is made from grains, cereal grasses or legumes. Examples of grains include, but are not limited to, wheat, corn, soybean, sunflower, barley, rye, oats, millet and flaxseed. Cereal grasses include any of the aforementioned grasses of their respective grains. Examples of legumes include, but are not limited to, beans such as kidney beans, lima beans, garbanzo beans, red beans, and pinto beans; peas such as black-eyed peas, split peas, and cow peas; and lentils. The dry aspect of the bakery product means that the bakery product is substantially free of water. Examples of dry bakery products, include, but are not limited to, leavened bread, unleavened bread, biscuits, tarts, bread crumbs, bread sticks, rolls, pretzels, cereal, doughnuts, cracker meal, crackers, scones, toasts, brownies, muffins, tarts, cakes and pies. If a bakery product, for example a doughnut, has too much moisture, then it can be air-exposed or desiccated in order to remove the moisture. Note than any of the bakery products that are the source of the starch-base have already been baked.

The starch-base can be a single dry bakery product, such as bread crumbs, or a combination of two dry bakery products such as bread and pretzels. The starch-base can also include meal, or the powderized form of cereal grass seeds.

A preferred starch base is a combination of bread crumbs and cracker meal. These two ingredients can be blended in any ratio to form the starch-base. For example, the ratio of bread crumbs to cracker meal can range from about 3:1 to about 1:3, or preferably 3:2.

An important aspect of the starch-base is that the starch-base should be ground or crumbled into small particles, for example by a mortar and pestle. For example, the average particle size can range from about 0.01 to 5 mm, e.g., about 0.1 to about 2.5 mm. The starch-base can be ground into particles of uniform size or particles of varying sizes; however, particles of non-uniform sizes are preferred because they result in more favorable bread equivalent attributes. For example, a starch-base that is primarily composed of large particles yields a bread equivalent that is too grainy and not smooth. However, a blend that consists solely of small particles, such as meal, yields a bread equivalent that is brittle with is a short texture that is very easily broken and difficult to handle. The starch-base should also be dry and free-flowing.

The next ingredient of the composition for use as a bread equivalent is a gelling agent. A “gelling agent” refers to any macromolecular substance that forms a gel by the addition of ions, heating and subsequent cooling or change in pH. Examples include, but are not limited to gellan gum, agar, cellulose derivatives (e.g., carboxymethyl cellulose), hydrocolloids, gelatin, xanthan gum, alginic acid, pectin, carrageenan and mixtures and derivatives thereof. When a gelling agent is dispersed in a vehicle such as water, and subjected to activation a cohesive gel structure is formed. For example, a preferred gelling agent used in the present invention is carrageenan. When a cation is introduced into a liquid containing dispersed carrageenan, a cohesive gel structure will result. The purpose of the gelling agent is to provide body and structure in the bread equivalent that causes the bread equivalent to be solid or semi-solid.

The appropriate concentration of gelling agent should be enough to render the bread equivalent solid enough to withstand slicing and the shear stress applied when a spreadable food, such as butter, is used.

Any type of carrageenan can be used in the present invention, for example kappa carrageenan, iota carrageenan and lambda carrageenan. Any type of suitable cation can be used. For example if kappa carrageenan is to be used an example of an suitable cation is potassium. If iota carrageenan is used then calcium can be used for the cation. The gelling agent can also be a combination of kappa carrageenan and iota carrageenan.

The third component of the bread equivalent is a liquid vehicle when mixed with a gelling agent can form a structured matrix. This vehicle can be water or other type of beverage. Examples of beverages include, but are not limited to, milk, juice, nutritional supplements, soda, coffee and tea.

In addition to the starch-base, gelling agent and liquid vehicle, the bread equivalent can further include any ingredients that are used in food science. Examples of such ingredients include, but are not limited to, colorants, preservatives, emulsifiers, food starch, salt, vitamins, minerals, processing aids (e.g., mono and diglycerides), fiber sources (e.g., wheat germ), flavor enhancers, texture modifiers, oil, artificial flavoring (e.g., butter flavor or yeast flavors), natural flavoring (e.g., spices such as cinnamon and herbs), and protein sources (e.g., egg yolk solids or whole egg solids or dried milk).

In order to make the bread equivalent, the starch-base is first blended with the gelling agent to form a dry mix. This mix can also include a source of the cation used to active the gelling agent. For example, the source can be a salt such as sodium chloride, potassium chloride or calcium chloride. The dry mix is blended using any type of conventional mixing equipment such as a mixer. The dry mix can also include any of the aforementioned food science ingredients. Once blended, the dry mix can be packaged for shipment to an end-user, such as a healthcare provider.

The dry mix should contain from about 5% to about 95% of starch base by weight of the dry mix, preferably, the concentration can be from about 10% to about 80% or more preferably about 30% to about 70%. The dry mix should contain from about 0.25% to about 10% of gelling agent by weight of the dry mix, preferably, the concentration can be from about 0.5% to about 6% or more preferably from about 1% to about 3%.

Once an end-user receives the dry mix, that individual can make the bread equivalent by adding a liquid vehicle. For example, water, a liquid vehicle, is first heated to a temperature from about 60° C. to about 100° C., preferably about 65° C. The water is then added to the dry mix to form a batter. For example, the ratio of dry mix to water can range from about 1:1 to about 1:6, preferably, from about 1:2 to about 1:4. The entire mixture is agitated by any type of agitation means, for example a spoon, wire whip or mixer. The agitation is performed until the dry mix is uniformly dispersed in the liquid vehicle, and the gelling agent is allowed to set and form a gel. The purpose of heating the liquid vehicle is to facilitate the dispersion of the dry mix as well as to lower the viscosity of the batter to make the batter more flowable. Also, for some gelling systems, heat aids the activation of the gelling system. In some application, heat is also required to aid in activating the gelling system. The batter can be then poured into a mold or a tray, such as a loaf pan, or any other shape desired. The batter is then allowed to cool, for example, to room temperature or about 25° C. Once cooled, the bread equivalent is formed in the mold. Note that the entire bread equivalent is not baked, steamed or fried. The only aspect of the bread equivalent that is baked is the original starch-base. Forming and making the bread equivalent does not require the batter to be baked.

One of the advantages of the bread equivalent of the present invention compared to other bread substitutes such as mashed bread is that the bread equivalent has a mechanical integrity similar to that of bread at room temperature or about 25° C. Mechanical integrity refers to three specific aspects of bread and bread equivalents, that is shape retention, resistance to spreading, and slicing.

Shape retention refers to the ability of bread to retain its general shape even when handled by a person. For example, when dough is baked into a particular shape in a pan, such as a loaf, the loaf of bread will retain the shape of the pan even when it is being handled. Similarly, when the bread equivalents of the present invention are molded in a particular shape when setting up in a pan, the bread equivalents still retain the shape of the pan even after removal from the pan. Thus, the bread equivalents are relatively solid or semi-solid. Contrast this with mashed bread which cannot be handled simultaneously retain its shape. The rigidity of the bread equivalents of the present invention also enable the bread equivalents to be transported without the need for freezing or refrigeration.

Bread is also commonly used as a carrier for spreadable foods. For example bread must be able to withstand to shear force from the application of a spreadable food. Spreadable foods include, but are not limited to, butter, honey, margarine, jams, jellies, preserves, marmalades, peanut butter, cream cheese, cheese spread, sour cream and yogurt. In a study conducted by C. R. Daubert et al. of North Carolina State University, the spreadability of various foods were examined. Daubert showed that some spreadable foods required as much stress as 5000 Pa in order for them to spread. The study is disclosed in Daubert et al., Quantitative Measurement of Food Spreadability Using the Vane Method, 29 JOURNAL OF TEXTURE STUDIES 427 hereby incorporated by reference. The bread equivalents of the present invention have enough mechanical strength to withstand the spreading of foods that require a yield stress from about 50 to about 5000 Pa in order for them to flow, more preferably, from about 100 to 2000 Pa and thus are appropriate for use with spreadable foods. Mashed bread, on the other hand, cannot have a spreadable food applied to it in a layered fashion.

The last aspect of the mechanical integrity of bread is that it must be able to withstand slicing. For example, if a square piece of bread were cut along its diagonal with a knife, two pieces of triangular bread would result. Similarly, if a square piece of bread equivalent of the present invention were taken and sliced along the diagonal, then two triangular pieces of bread would result. It is the ability to withstand slicing that enables bread and the bread equivalents of the present invention to be made into sandwiches. Slicing into mashed bread would not result in two discrete pieces of mashed bread. Instead the mashed bread would flow and obscure any separation made by a knife.

The following examples are illustrations of the present invention and are not intended to limit the scope of the invention in any manner.

### EXAMPLE 1

### Dry Mix

An example of a dry mix that can be used in conjunction with a liquid vehicle to make a bread equivalent is set forth in the following table.

| Ingredient | Function | W/w % |
|---|---|---|
| bread crumb | starch-base | 68.85% |
| nonfat dried milk | protein source | 14% |
| natural flavors (yeast and butter) | flavoring | 1.5% |
| wheat germ | fiber | 6% |
| carrageenan | gelling agent | 3% |
| potassium chloride | gelling activator | 1% |
| mono and diglycerides | processing aid | 0.6% |
| modified corn starch | texture modifier | 0.5% |
| caramel coloring | colorant | 0.05% |

The above ingredients can be blended together in an appropriate mixer, such as a planatary mixer or ribbon blender. The ingredients are blended together for about five minutes. After mixing, the dried products can be packaged.

### EXAMPLE 2

### Dry Mix

In another example, 40 pounds (˜18 kg) of American bread crumbs (available as #72191 from Newlyweds Foods of Mississauga, ON) are combined with 25 pounds (˜11.3 kg) of cracker meal (#1151 of Newlyweds Foods). This is blended for about five minutes in a planatary mixer. Then, mono and diglycerides is spray dried into the dry mix. Three pounds of kappa carrageenan (available as Seakem CM611 available from FMC Corporation of Philadelphia, Pa.) and one pound of potassium chloride are then added to the dry mix. Subsequent to the addition of the gelling agent, 0.5 pounds of food starch, 0.2 pounds of salt and seven pounds of dried flavoring and colorants are added. The dry mix is then mixed for an addition five minutes.

### EXAMPLE 3

### Formation of the Bread Equivalent

For example, for a single serving of bread equivalent (e.g., 82 gm of finished bread equivalent), measure two tablespoons (29.57 ml or 22 gms) of the dry mix and add about ¼ cup (59.15 ml) of water that has a temperature of at least 60° C. The ratio of dry mix to water is about 1:3. The dry mix is agitated with a wire whip or spoon until it is thoroughly blended to form a batter. Once blended, the batter can be poured into a bread mold or spread on a small plate. After approximately ten minutes, the bread equivalent will gel and set-up. The bread equivalent can then be sliced or served to a patient. If larger servings are prepared, then more time may be required for the batter to set-up. For example, if five servings were made, then approximately fifteen minutes are required for the batter to set-up.

### Nutritional Comparison of the Bread Equivalent to Bread

The following table compares the nutritional profile of the bread equivalent to a single slice of wheat bread. The nutritional information for the slice of wheat bread is taken from JEAN PENNINGTON, BOWES AND CHURCH's FOOD VALUES OF PORTIONS COMMONLY USED, 108-109 (15^{th} Ed. 1989).

| | | 1 Slice Wheat Bread as defined in, |
|---|---|---|
| | Bread Equivalent made from | BOWES AND CHURCH'S FOOD VALUES |
| | formula disclosed in Example 1 | OF PORTIONS COMMONLY USED |
| Serving size g | 82 | 24 |
| Calories | 80 | 61 |
| Total fat g | 1 | 1 |
| Total carbohydrate | 15 | 11.3 |
| Sugars g | 3 | 0 |
| Dietary fiber g | 3 | 0 |
| Protein | 3 | 2.3 |
| Sodium mg | 140 | 129 |
| Potassium mg | 220 | 33 |
| Vitamin A IU | 0 | 0 |
| Vitamin C mg | 0 | 0 |
| Calcium mg | 60 | 30 |
| Iron mg | 0.85 | 0.84 |
| Thiamine mg | 0.11 | 0.11 |
| Riboflavin mg | 0.085 | 0.08 |
| Niacin mg | 1 | 1.1 |
| B₆ mg | 0.04 | 0.03 |
| Folic acid mg | 12 | 11 |
| Magnesium mg | 12 | 11 |
| Copper | 0.06 | 0.058 |
| Manganese | 0.03 | 0 |

As shown in the above table the bread equivalent has a nutrition profile comparable to that of bread. The above table shows a nutritional profile for the bread equivalent that is comparable to wheat bread. One skilled in the art can modify the composition of the bread equivalent to match the nutrition profile of any type of bread not just wheat bread, for example white bread, whole wheat bread, rye bread, pumpernickel, etc. The nutrition profile can be adjusted by changing the starch-base of the bread equivalent.

It is understood that while the present invention has been described in conjunction with the detailed description thereof that the foregoing description is intended to illustrate and not limit the scope of the invention, which is defined by the scope of the following claims. Other aspects, advantages and modifications are within the scope of the claims.

What is claimed:

1. A bread equivalent suitable for patients suffering from dysphagia comprising:
a starch-base;
a gelling agent; and
a liquid vehicle;
wherein the bread equivalent has a mechanical integrity at about room temperature similar to bread.

2. The bread equivalent of claim 1, wherein the starch-base comprises a dry bakery product made from a grain selected from the group consisting of wheat, corn, soybean, sunflower, barley, rye, oats, millet and flaxseed.

3. The bread equivalent of claim 1, wherein the starch-base comprises bread crumbs.

4. The bread equivalent of claim 3, wherein the starch-base further comprises cracker meal.

5. The bread equivalent of claim 1, wherein the gelling agent is selected from the group consisting of gellan gum, agar, cellulose derivatives, hydrocolloids, gelatin, alginic acid, pectin, carrageenan and mixtures thereof.

6. The bread equivalent of claim 1, wherein the bread equivalent can withstand the force exerted from an application of a spreadable food.

7. The bread equivalent of claim 6, wherein the force is from about 50 to about 5000 Pa.

8. The bread equivalent of claim 1, wherein the bread equivalent further comprises a cation selected from the group consisting of sodium, potassium and calcium.

9. The bread equivalent of claim 1, where in the starch-base has an average particle size from about 0.01 mm to about 5 mm.

10. The bread equivalent of claim 9, wherein the starch-base has an average particle size from about 0.1 mm to about 2.5 mm.

11. The bread equivalent of claim 1, wherein the dry mix and the liquid vehicle are present in a ratio from about 1:1 to about 1:6.

12. A dry mix for a bread equivalent for patients suffering from dysphagia comprising:
a starch-base, the starch-base being present in a concentration from about 5 to about 95% by weight of the composition; and
a gelling agent, the gelling agent being present in a concentration from about 0.25 to about 10% by weight of the composition;
wherein when the dry mix is dispersed in a liquid vehicle, the dry mix in the liquid vehicle forms a bread equivalent having a mechanical integrity at about room temperature similar to bread.

13. The dry mix of claim 11, wherein the liquid vehicle is water having a temperature of at least 60° C.

14. The dry mix of claim 11, wherein the starch-base comprises a dry bakery product made from a grain selected from the group consisting of wheat, corn, soybean, sunflower, barley, rye, oats, millet and flaxseed.

15. The dry mix of claim 11, wherein the starch-base comprises bread crumbs.

16. The dry mix of claim 15 wherein the gelling agent is selected from the group consisting of gellan gum, agar, cellulose derivatives, hydrocolloids, gelatin, alginic acid, pectin, carrageenan and mixtures thereof.

17. The dry mix of claim 16, wherein the dry mix further comprises a cation.

18. A method of making a bread equivalent suitable for patients with dysphagia comprising the steps of:
blending a starch-base with a gelling agent to form a dry mix;
dispersing the dry mix in a liquid vehicle to form a batter; and
shaping the batter to form a bread equivalent;
wherein the bread equivalent having a mechanical integrity at about 25° C. similar to bread.

19. The method of claim 18, wherein the starch-base comprises a dry bakery product made from a grain selected from the group consisting of wheat, corn, soybean, sunflower, barley, rye, oats, millet and flaxseed.

20. The method of claim 19, wherein the starch-base is bread crumbs.

21. The method of claim 19, wherein the gelling agent is selected from the group consisting of gellan gum, agar, cellulose derivatives, hydrocolloids, gelatin, alginic acid, pectin, carrageenan and mixtures thereof.

22. The method of claim 19, wherein the liquid vehicle is water having a temperature of at least 60° C.

23. The method of claim 19, wherein the bread equivalent can withstand the force exerted from an application of a spreadable food.

24. The method of claim 23, wherein the force is from about 50 to about 5000 Pa.

25. A bread equivalent suitable for patients suffering from dysphagia comprising:
a starch-base, wherein the starch-base is bread crumbs;
carrageenan; and
water;
wherein the bread equivalent has a mechanical integrity at about room temperature similar to bread.

26. The bread equivalent of claim 25, wherein the bread equivalent further comprises mono and diglycerides.
